(19) United States
(12) Patent Application Publication
(10) Pub. No.: US 2009/0243965 A1
(43) Pub. Date: Oct. 1, 2009

(54) LIGHTWEIGHT HEAD MOUNTED DISPLAY WITH MULTIPLE ADJUSTMENTS

(76) Inventors: Joel Price, Chevy Chase, MD (US); Lawrence G. Brown, Towson, MD (US); Marc D. Shapiro, Parkville, MD (US)

Correspondence Address: KASHA LAW LLC, 10310 POTOMAC CORNER DRIVE, ROCKVILLE, MD, 20850, US

(21) Appl. No.: 12/281,014

(22) PCT Filed: Feb. 28, 2007
(86) PCT No.: PCT/US07/04948

§ 371 Date: Dec. 23, 2008

Related U.S. Application Data
(60) Provisional application No. 60/743,391, filed on Mar. 1, 2006.

(51) Int. Cl. G09G 5/00

(52) U.S. Cl. 345/8

(57) ABSTRACT

A head mounted display assembly including a frame comprising a base (5) adapted to rest on a top portion of a head of a user, a front frame portion (4) adapted to rest against a front portion of the head of the user, and a rear frame portion (6) adapted to rest against a back portion of the head of the user. The assembly also includes an optical display housing (2). Additionally, the assembly includes an adjustment mechanism configured to adjust a distance between the front frame portion (4) and the rear frame portion (6) while maintaining the optical display housing (2) at a constant angle relative to the base (5). The instant abstract is neither intended to define the invention disclosed in the specification nor intended to limit the scope of the invention in any way.

### CROSS-REFERENCE TO RELATED APPLICATIONS

The present invention claims priority to U.S. Provisional Application No. 60/743,391 filed on Mar. 1, 2006, the disclosure of which is expressly incorporated by reference herein in its entirety.

### BACKGROUND OF THE INVENTION

1. Field of the Invention

The invention relates to a head mounted display and, more particularly, to a head mounted display having multiple adjustments.

2. Discussion of Background Information

A Head Mounted Display (HMD) is commonly known as a device worn on a user's head to have video information directly displayed in front of their own eyes. HMDs are often used for simulating virtual reality environments for various industries including entertainment, military training, vehicular and architectural design, medical simulation and many other applications.

HMD designs to date have suffered from a combination of common problems including neck and head discomfort from excessive weight and general bulkiness, lack of proper adjustments to accommodate for a wide range of head sizes, head shapes and eye positions, and general user friendliness. Proper location of the information displays relative to the eye positions ensures optimum performance of the incorporated optical image system. The optical image system typically includes both the image displays (e.g. Liquid Crystal Display (LCD) or Organic Light Emitting Diodes (OLED)), magnification and focusing optics, tracking and display control electronics and associated cables. As technology continues to improve across numerous related industries, virtual reality HMDs are able to more accurately replicate environments that match human vision. These new improved displays, optics, and control electronics with more true color, higher resolution, and larger field-of-view enable HMDs to portray more realistic binocular 3-D images than ever before. However, the incorporation of these new improved technologies, poses new challenges for the HMD design in terms of overall weight, required adjustments and user friendliness.

### SUMMARY OF THE INVENTION

The HMD design of the present invention incorporates innovative approaches to creating a lightweight device with multiple adjustments and overall user friendliness. This design of the present invention improves on both the current state of virtual reality HMD designs and the requirements foreseen for incorporation of future technology improvements.

More specifically, according to a first aspect of the invention, there is an apparatus comprising a frame. The frame includes a front frame portion adapted to rest on a front portion of a head of a user, and a rear frame portion adapted to rest on a back portion of the head of the user. The apparatus further comprises at least one adjustment mechanism configured to secure the frame to the head of the user. Additionally, the apparatus includes a downwardly extending housing member proximate the front frame portion, the housing member being configured to house an optical display.

In embodiments, the frame is adjustable. Moreover, the rear frame portion may be adjustable. Also, the at least one adjustment mechanism may selectively adjust a distance between the front frame portion and the rear frame portion.

The apparatus may further comprise a mechanism configured to adjust a position of the optical display relative to eyes of the user. Furthermore, in implementations, the housing member remains substantially vertical during adjustment of the frame.

The at least one adjustment mechanism may be located at a top portion of the frame. Also, the at least one adjustment mechanism may comprise a rotatable mechanism configured to move at least a portion of the frame for securing the frame to the head of the user.

The at least one adjustment mechanism may comprise two adjustment mechanisms, each being configured to adjust separate portions of the frame. Alternatively, the at least one adjustment mechanism may comprise a single adjustment mechanism that adjusts plural portions of the frame. Moreover, the single adjustment mechanism comprises a single rotational adjustment mechanism.

In accordance with a second aspect of the invention, there is an assembly comprising a frame. The frame includes a base having a first end and a second end, a first member coupled to the first end, and a second member coupled to the second end. The assembly further comprises an optical display housing and an adjustment mechanism structured to provide equal-angular countermovement of the first member and the second member relative to the base, and movement of the optical display housing.

The assembly may further comprise a frame member coupled to the optical display housing and the first member. In embodiments, the adjustment mechanism is structured to provide movement of the frame member relative to the first member such that the optical display housing remains in a substantially vertical orientation relative to the base. During adjustment, movement of the frame member relative to the first member may be equal in magnitude and opposite in angular direction to movement of the first member relative to the base. Additionally, during adjustment, movement of the frame member relative to the first member may be equal in magnitude and angular direction to movement of the second member relative to the base. Furthermore, the frame member may be hinge-mounted to the first member and configured to lock at a first angle and a vertical angle relative to the base.

The assembly may further comprise an interpupillary distance adjustment mechanism structured and arranged to adjust an optical display housed within the optical display housing. For example, the interpupillary distance adjustment mechanism may comprise a spur gear operatively engaged with two racks that are configured to move portions of the optical display toward or away from each other.

The assembly may further comprise at least one of: a vertex distance adjustment mechanism structured and arranged to adjust a vertex position of the optical display housing relative to the frame member; and a vertical distance adjustment mechanism structured and arranged to adjust a vertical position of the optical display housing relative to the frame member. For example, the vertex distance adjustment mechanism may comprise biased finger controls that selectively allow the optical display housing to move along rails extending substantially horizontal with respect to eyes of a user. Additionally or alternatively, the vertical distance adjustment mechanism may comprise biased finger controls that selectively allow the optical display housing to move along rails extending substantially vertical with respect to eyes of a user.

In implementations, the assembly also comprises a flexible connector boot coupled to the second member and structured to connect cables from the optical display housing to cables from a signal source.

According to a third aspect of the invention, there is a head mounted display assembly comprising a frame. The frame includes a base adapted to rest on a top portion of a head of a user, a front frame portion adapted to rest against a front portion of the head of the user, and a rear frame portion adapted to rest against a back portion of the head of the user. The head mounted display assembly further includes an optical display housing and an adjustment mechanism configured to adjust a distance between the front frame portion and the rear frame portion while maintaining the optical display housing at a constant angle relative to the base.

The head mounted display assembly may further comprise a flexible connector boot coupled to the rear frame portion and connecting at least one signal cable from the optical display housing to at least one signal cable from a signal source.

Moreover, the head mounted display assembly may include a belt-pack assembly connecting at least one signal cable from the flexible connector boot to the at least one signal cable from the signal source.

According to a fourth aspect of the invention, there is a head-mounted display comprising a C-shape frame member having contact points at a top, front and rear of a user's head. The head mounted display also includes at least one adjustment mechanism arranged with the C-shaped frame member and structured to adjust at least one of the contact points of the C-shaped frame member. Additionally, there is a housing structured to house an optical display system proximate to a user's eyes and extending from the C-shape frame member. The contact point at the rear of the user's head may be essentially concave shaped.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIGS. 1A and 1B show a head mounted display (HMD) according to aspects of the invention;

FIG. 2 shows further details of an HMD according to aspects of the invention;

FIG. 3 shows further details of an HMD according to aspects of the invention;

FIGS. 4A through 4I show various views of a user wearing an HMD according to aspects of the invention;

FIGS. 5A through 5I show various views of an HMD according to aspects of the invention;

FIGS. 6A through 6C show further details of an HMD according to aspects of the invention;

FIGS. 7A and 7B show further details of an HMD according to aspects of the invention;

FIGS. 8A through 8C show further details of an HMD according to aspects of the invention;

FIGS. 9A through 9F show further details of an HMD according to aspects of the invention;

FIGS. 10A through 10C show various components of an HMD according to aspects of the invention;

FIGS. 11A through 11G show adjustment mechanisms according to aspects of the invention;

FIGS. 12A through 12K show a connector boot assembly according to aspects of the invention; and

FIGS. 13A through 13G show a belt pack assembly according to aspects of the invention.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Implementations of the HMD of the present invention incorporate innovative approaches to creating a lightweight device (e.g., approximately two pounds) with multiple adjustments and overall user friendliness. Embodiments of the present invention improve on both the current state of virtual reality HMD designs and the requirements foreseen for incorporation of future technology improvements referred to generally as another company's proprietary material. As used herein, the term “proprietary” refers to systems which make no part of the invention, and which were or are being developed by third parties such as, for example, a display and optical image system and accompanying electronics, and the specific functionality associated therewith.

Moreover, implementations of the HMD according to aspects of the invention may be integrated with any known cable assembly, display and optical image system, motion tracker system and accompanying electronics. The optical image system, motion tracker system and accompanying electronics may be proprietary to other parties, in which case, such systems make no part of the invention.

In order to create an HMD with both minimal weight and overall lightweight perception by the user during normal operation, it is helpful to closely align the center of masses of both the HMD and user's head. In this manner, the present invention provides a snug fit, front-to-back, over-the-head, jointed HMD design which minimizes the amount of weight cantilevered away from the centerline of the head and neck. This design of the present invention reduces stress and fatigue for the user over extended periods of time. In addition, the centerline configuration enables optimal placement of motion tracking devices, as well as other components.

Unlike many other HMD designs that have fixed parts that are made large enough to accommodate the maximums, the jointed design of the present invention ensures optimum flexibility for various size and shaped heads, while maintaining a snug fit. In embodiments, the narrow band across the top centerline of the head, the open concave shape on the back of the head, and the wrap around front optics cover pair, alone or in combination, ensure a minimum number of contact points on the head to help ensure the optimal balance between a secure fit required for normal head motions and minimal discomfort over time. An additional benefit to this design configuration of the present invention is the avoidance of typical hair management issues.

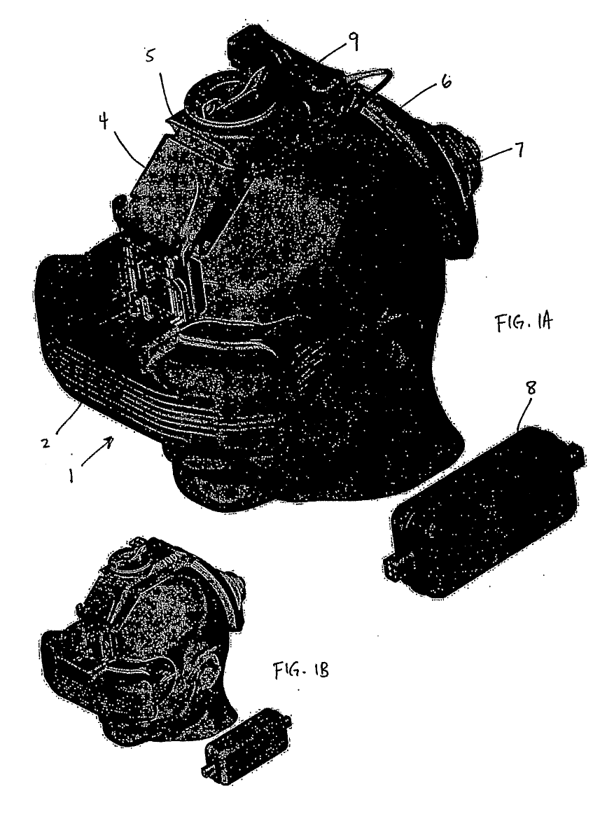

FIGS. 1A and 1B show implementations of an HMD according to aspects of the invention. Generally, as shown in FIGS. 1A and 1B, embodiments of the HMD according to the present invention include a display and optical image system 1 housed in a wrap around front optical cover 2, a vertical member 3, a front angle member 4, a top horizontal base 5, an open concave rear head support 6, a flexible connector boot assembly 7, and a belt-pack assembly 8. The embodiment shown in FIG. 1A comprises an optional motion tracking sensor 9, described in further detail below, whereas, the embodiment shown in FIG. 1B does not include the motion tracking sensor.

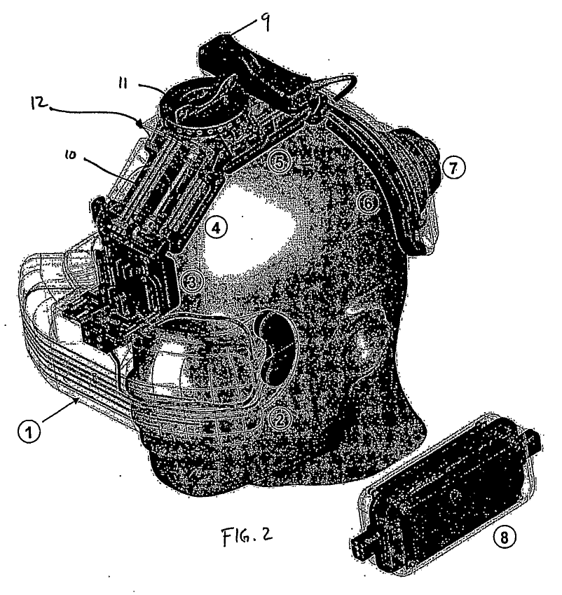

Referring to FIG. 2, the HMD includes several adjustable components. These components include, in embodiments, the display and optical image system 1, which comprises a proprietary optical image system that displays images to one or both of a user's eyes. The wrap around front optical cover 2 houses the display and optical image system 1 and provides ambient light protection and facial padding. Vertical member 3 provides for optical adjustments including interpupillary distance (IPD), vertex, and vertical adjustment. The vertical member 3 also provides for an approximate ninety degree flip-up of the display and optical image system 1 and wrap around front optical cover 2. Front angle member 4 is coupled to the vertical member 3 and provides a rotation transfer mechanism and cable channels 10. The top horizontal base 5 is coupled to the front angle member 4 and provides a main gear assembly, cable channels 10, and a head size adjustment handle 11 (described in greater detail below). The top horizontal base 5 may further include a motion tracking sensor 9 (described in greater detail below) and a cover 12.

The rear head support 6 may be an open, concave design, and is coupled to base 5 and accommodates cable channels 10. Flexible connector boot assembly 7 may be configured to accommodate various cables. The belt-pack assembly 8 may comprise bi-directional cable strain reliefs, status windows, and protective gaskets, and may be configured to accommodate control electronics for the display and optical image system 1. The belt-pack assembly 8, flexible connector boot assembly 7, and cable channels 10 provide a system for routing signal carrying cables (i.e., wires) from a signal source (i.e., computer cluster) to the display and optical image system 1.

As described above, a motion tracking sensor 9 may be mounted on the HMD. As is understood to those of skill in the art, such that further explanation is not needed herein, a motion tracking sensor detects movement of the HMD on the user's head, such that a computer may properly update the images displayed on the display and optical image system 1. Any suitable, known motion tracking sensor 9 may be used with the invention.

### Relationship Between Components

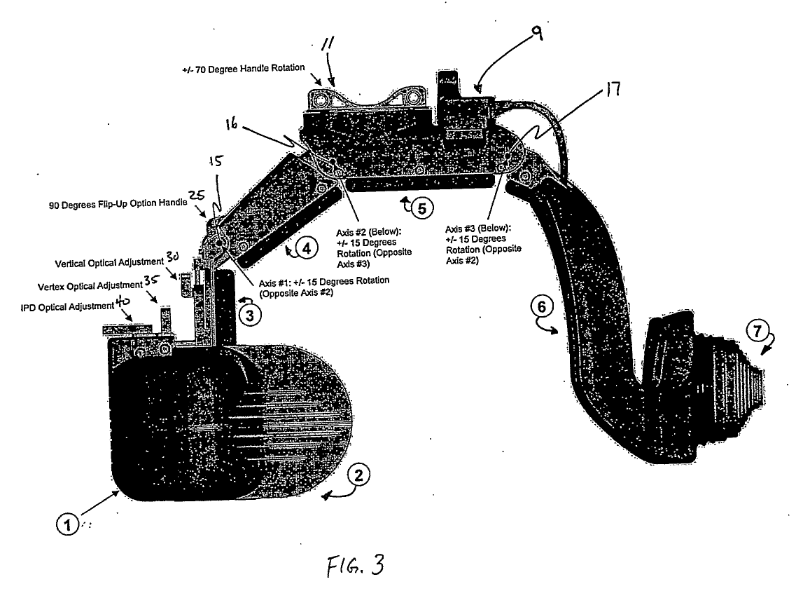

FIG. 3 shows an exemplary relationship between components of the HMD according to aspects of the invention. The display and optical image system 1, which projects images for displaying to a user, is contained within the wrap around front optical cover 2. The wrap around front optical cover 2 is coupled to the vertical member 3. The vertical member 3 is coupled to the front angle member 4 and may rotate relative to the front angle member 4 about first axis 15. The front angle member 4 is coupled to the top horizontal base 5 and may rotate relative thereto about second axis 16. The top horizontal base 5 is coupled to the rear head support 6 and may rotate relative thereto about third axis 17. The flexible connector boot assembly 7 is coupled to the open concave rear head support 6.

Also shown in FIG. 3 are an adjustment handle 11, flip-up handle 25, vertical adjustment mechanism 30, vertex adjustment mechanism 35, and interpupillary distance (IPD) adjustment mechanism 40, which are described in greater detail below. Moreover, in embodiments, the HMD may optionally comprise a motion tracking sensor 9.

As is described herein, rotation of the adjustment handle 11 causes rotation of the vertical member 3 relative to the front angular member 4, rotation of the front angular member 4 relative to the base 5, and rotation of the back head support 6 relative to the base 5. These movements allow the HMD to gradually squeeze (or release) a user's head, from the forehead to the back of the head, until a proper comfort fit is achieved. In embodiments, this is accomplished via equal magnitude counter-movements of the front angular member 4 and the back head support 6, while the vertical member 3 is maintained in a substantially vertical orientation with respect to the base 5.

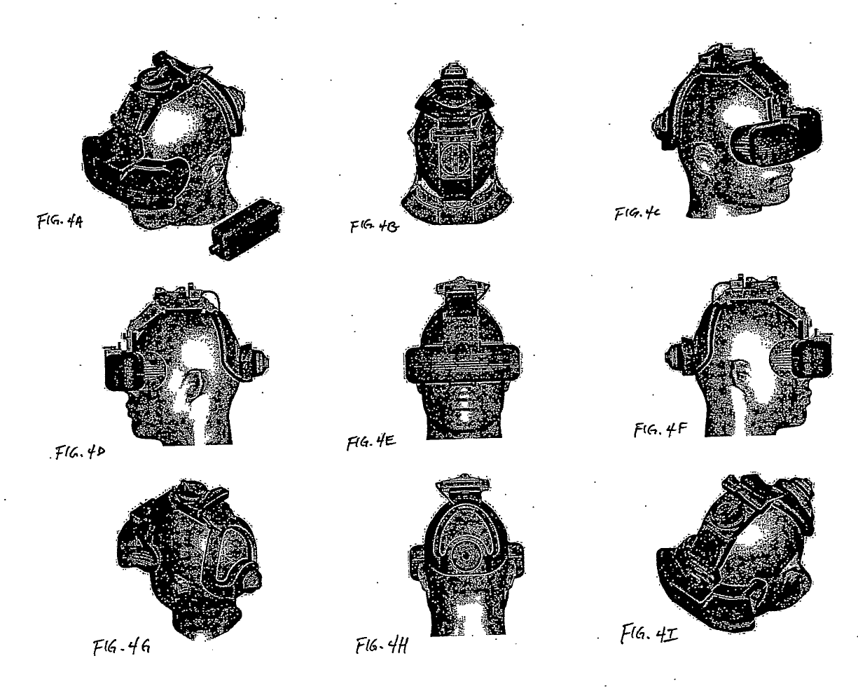

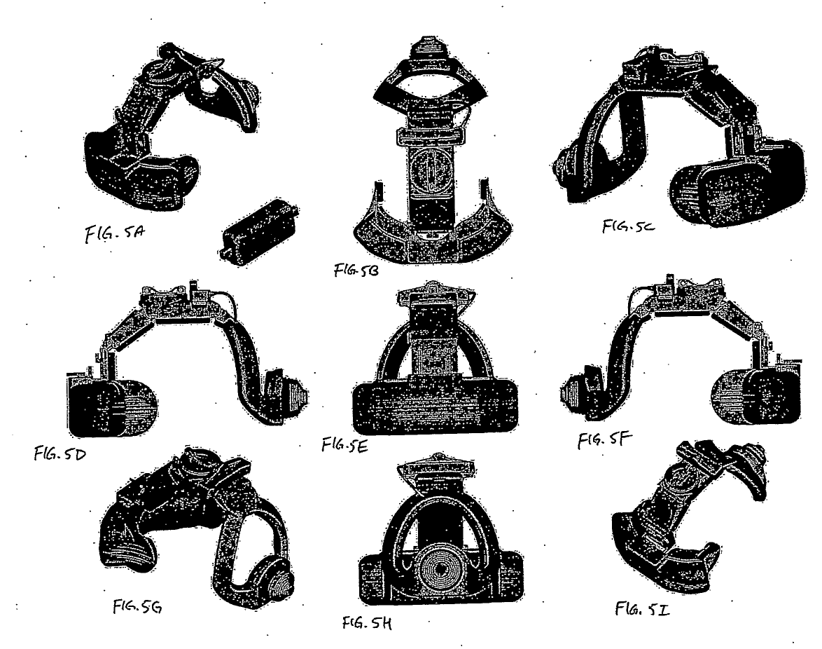

FIGS. 4A through 4I show various perspective views of a user wearing the HMD according to aspects of the invention. Additionally, FIGS. 5A through 5I depict various perspective views of the HMD according to aspects of the invention.

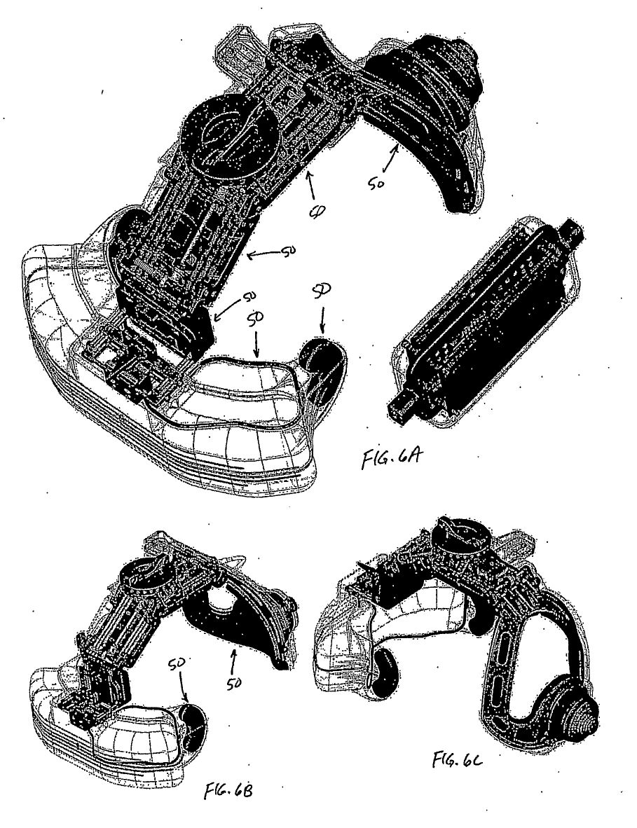

FIGS. 6A through 6C show more detailed views of the HMD according to aspects of the invention. In embodiments, various parts of the HMD may be provided with padding 50 to provide a snug fit of the HMD on the user and comfort for the user. For example, the padding 50 may create a seal around the wrap around front optical cover 2. Additionally, the padding 50 minimizes side motion of the HMD by compressing portions of the user's head. The padding 50 may comprise covered quick recovery foam, as is known in the art. Moreover, the padding 50 may be removed from the various parts of the HMD.

### Adjustment Mechanisms

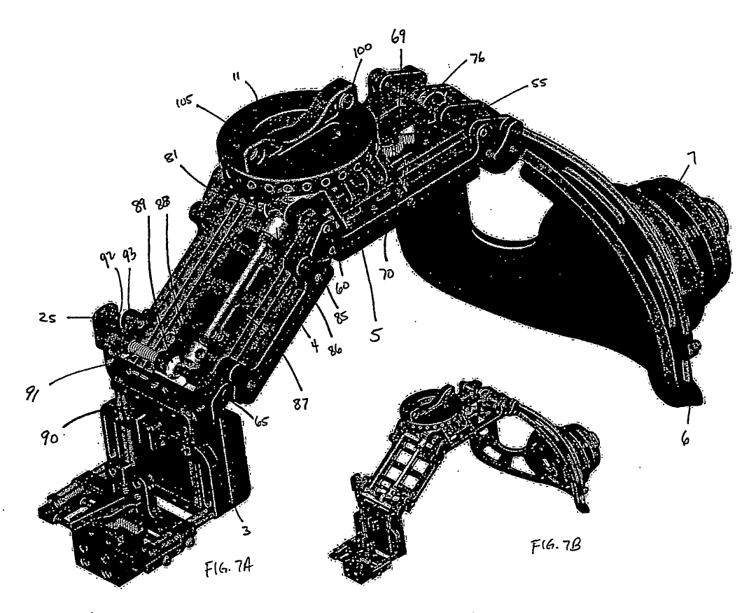

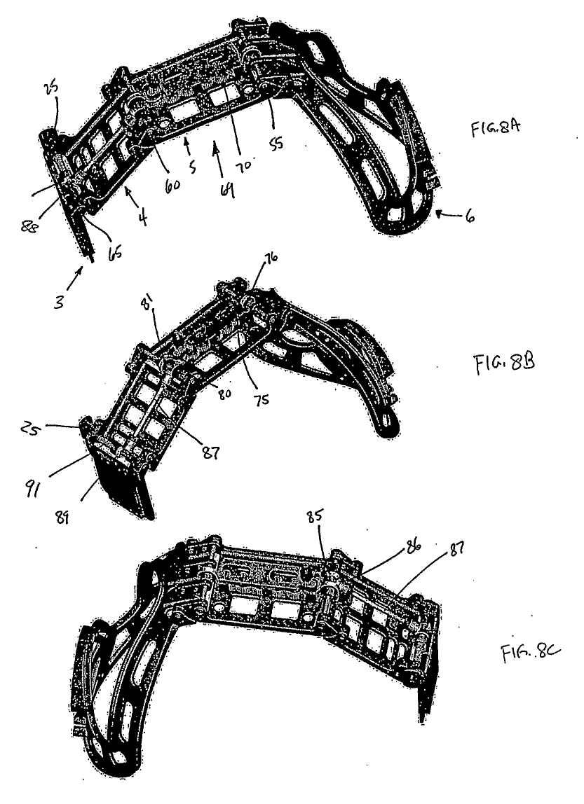

FIGS. 7A through 8C show details of adjustment mechanisms and related components of the HMD, according to aspects of the invention. As seen in FIG. 7A, rear pivot shaft 55 pivotally connects the base 5 to the rear head support 6, and front pivot shaft 60 pivotally connects the base 5 to the front angle member 4. Moreover, a split pivot shaft 65 pivotally connects the vertical member 3 to the front angle member 4.

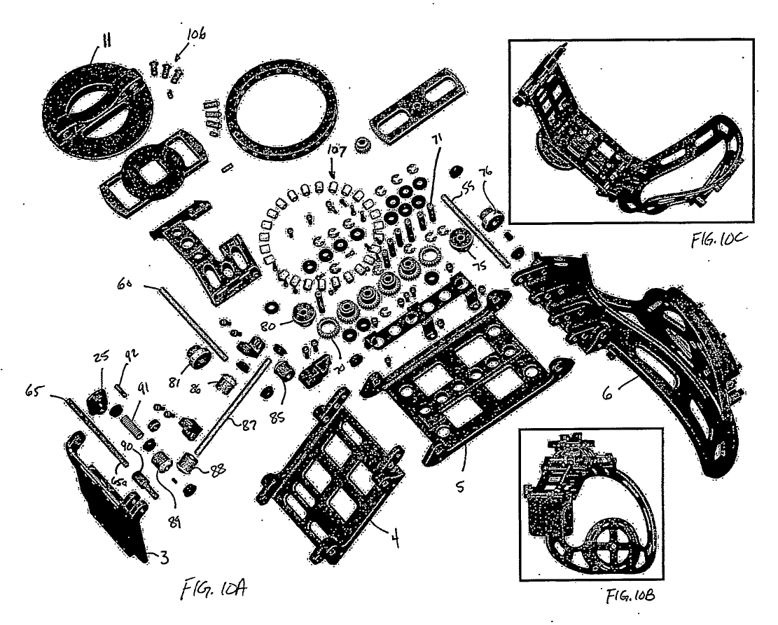

A gear set 69 of engaged spur gears 70 (best seen in FIGS. 7A and 8A) is provided on the base 5. In embodiments, the spur gears 70 are arranged in a line, with each being rotatably mounted on the base 5 by respective shaft 71 (see FIG. 10A) coupled to the base 5. In the embodiment shown, six spur gears 70 are provided, although the gear set may include a different number of spur gears 70. One of the spur gears 70 is operatively coupled to the adjustment handle 11, such that rotation of the adjustment handle 11 causes rotation of all of the spur gears 70 within the gear set. For example, the fourth spur gear of the gear set may be operatively coupled to the adjustment handle 11 by a suitable combination of additional gears and shafts. The spur gears 70, and all other gears described herein, may be composed of aluminum.

The spur gear 70 that is closest to the rear pivot shaft 55 (e.g., the sixth of the six gears of the gear set 69) is operatively coupled to a helical gear 75 (best seen in FIG. 8B). In embodiments, the helical gear 75 is mounted above the spur gear 70 on the same shaft that attaches the spur gear 70 to the base 5. Another helical gear 76 is mounted on the rear pivot shaft 55 and operatively engaged with helical gear 75, such that rotation of the adjustment handle 11 causes rotation of the rear head support 6 relative to the base 5.

Still referring to FIGS. 7A through 8C, the spur gear 70 that is closest to the front pivot shaft 60 (e.g., the first of the six gears of the gear set 69) is operatively coupled to a helical gear 80 (best seen in FIG. 8B) In embodiments, the helical gear 80 is mounted above the spur gear 70 on the same shaft that attaches the spur gear 70 to the base 5. Another helical gear 81 is mounted on the front pivot shaft 60 and operatively engaged with helical gear 80, such that rotation of the adjustment handle 11 causes rotation of the front angle member 4 relative to the base 5.

In embodiments, the gear ratios of the gear set of spur gears 70 and helical gears 75, 76, 80, and 81 are configured such that the rear head support 6 and front angle member 4 rotate in equal amounts in opposite directions relative to the base 5 when the adjustment handle 11 is turned. For example, helical gear 75 may be opposite-handed relative to helical gear 80. In one example, the gears are arranged such that a plus or minus seventy degree rotation of the adjustment handle 11 causes a plus or minus fifteen degree counter-movement of the front angle member 4 and the rear head support 6 about the base 5. However, other gear ratios may be used within the scope of the invention.

Still referring to FIGS. 8A through 8C, a bevel gear 85 is coupled to the front pivot shaft 60. Bevel gear 86 is mounted on a distal end of a transmission shaft 87 that is rotatably mounted on the front angle member 4. In embodiments, the transmission shaft 87 is orthogonal to the front pivot shaft 60. Bevel gear 38 is mounted on the other distal end of the transmission shaft 87. Bevel gear 89 is mounted on split pivot shaft 65. Bevel gears 85 and 86 are operatively engaged with each other, and bevel gears 88 and 89 are selectively operatively engaged with each other, such that rotation of the adjustment handle 11 causes rotation of the vertical member 3 relative to the front angle member 4.

In embodiments, the above-described gears are arranged such that, when the adjustment handle 11 is rotated, the vertical member 3 rotates in a direction about the front angle member 4 that is opposite to the direction that the front angle member 4 rotates about the base member 5. That is, the split pivot shaft 65 generally rotates in a direction opposite the front pivot shaft 60. Moreover, the gear ratios may be arranged such that the vertical member 3 rotates the same amount as the front angle member 4. This equal magnitude but opposite direction rotation of vertical member 3 ensures that the wrap around front cover 2 (and the display and optical image system 1 held therein) remain parallel to the user's eyes (i.e., substantially vertical) during adjustment of the head size of the HMD. Although certain gear ratios have been described, it is noted that other gear ratios may be used with the invention.

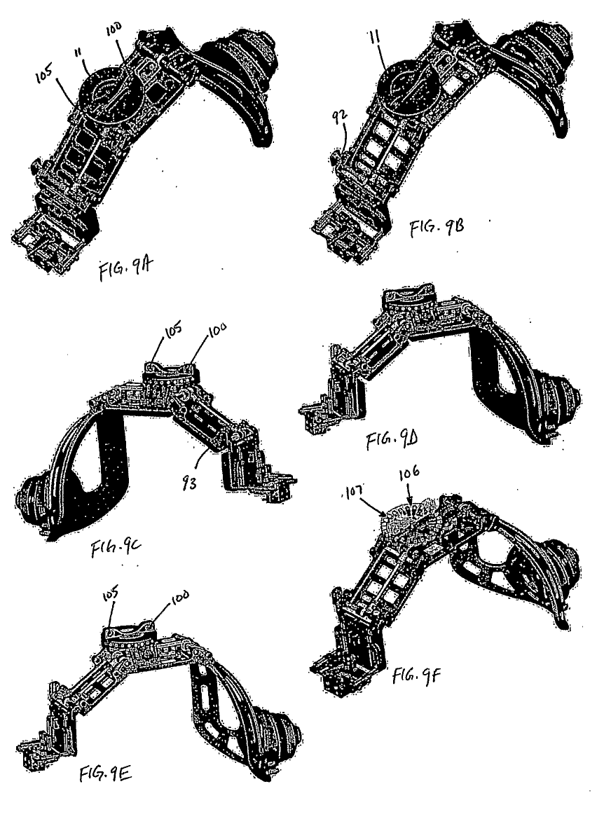

FIGS. 9A through 9F show the adjustment handle 11 coupled to the base member 5. In embodiments, the adjustment handle 11 comprises a unique shape that can help a user (either right-handed or left-handed) determine the proper direction required for adjustment (i.e., the proper direction of rotation of the adjustment handle 11) without actually seeing the adjustment handle 11. That is, the shape allows the user to simply feel (e.g., with a thumb and finger) the adjustment handle 11 to determine which direction to turn the adjustment handle 11 for proper adjustment. The unique shape may comprise, for example, at least one raised portion 100 and at least one indented portion 105 on certain, predetermined sides of the adjustment handle 11.

FIG. 9F shows the adjustment handle 11 in phantom lines, revealing that, in embodiments, the adjustment handle 11 and base member 5 incorporate six miniature spring loaded ball plungers 106 and twenty five matching detents 107. Thus, the adjustment handle 11 can be rotated to sixteen different positions, corresponding to sixteen different positions of the front angle member 4 and rear head support 6 relative to the base member 5. In exemplary implementations, the dimensions of the various components of the HMD are structured and arranged such that these sixteen positions allow the HMD to fit more than ninety seven and one half percent of the adult male and adult female head sizes in the general population. However, it is noted that any desirable number of spring loaded ball plungers and/or detents may be used, depending upon the intended use of the HMD.

In implementations, all of the above-described components are structured and arranged such that the adjustment handle 11 may be rotated plus or minus seventy degrees from a central position, resulting in rotation of plus or minus fifteen degrees of the vertical member 3, front angle member 4, and back head support 6, respectively, about their respective axes (i.e., first axis 15, second axis 16, and third axis 17).

FIGS. 10A through 100 show various components of the HMD according to aspects of the invention. In embodiments, the split pivot shaft 65 has a spring loaded square ended section 65a (see FIG. 10A) with a fine set screw adjustment that enters a mating receptacle 90 of the split shaft. A spring 91 biases the split pivot shaft 65 toward a first position in which bevel gear 89 engages bevel gear 88. In this first position, rotation of the adjustment handle 11 causes corresponding rotation of the vertical member 3, as described above.

The flip-up handle 25 is coupled to the split pivot shaft 65, and allows a user to axially move the split pivot shaft 65 against the force of the spring 91 to a second position. In the second position, bevel gear 89 does not engage bevel gear 88. As such, in the second position, the vertical member 3, and the displays, optics, and covers coupled to it, may be freely rotated relative to the front angle member 4. This disengagement allows the vertical member 3 to freely rotate through an angle of, for example, ninety degrees, such that the displays, optics, and covers are moved away from the user's eyes. In this manner, the disengagement permits a flip-up option for ease of normal user vision and various calibration procedures.

In further embodiments, the flip-up handle 25 comprises an insertion pin 92 that selectively engages a corresponding hole 93 on the front angle member 4. As such, a user may pull the flip-up handle 25 to disengage the bevel gears 88 and 89, then insert the insertion pin 92 into the hole 93 to hold the split pivot shaft 65 in the second (i.e., disengaged) position. Similarly, the user may remove the insertion pin 92 from the hole 93 and allow the spring 91 to move the split pivot shaft 65 back to the first (i.e., engaged) position. Accordingly, implementations of the invention provide a flip-up adjustment to enhance overall user friendliness.

Also, as can be seen in FIG. 10A, components that are readily known to those of skill in the art (such as, for example, screws, brackets, washers, etc.) may be used in assembling the HMD. As these components are well known to those of skill in the art, an explanation of each of these components is not undertaken herein. Instead, it is noted that one of skill in the art, in the context of the remaining disclosure, can assemble the HMD without any undue experimentation. It is also noted that FIG. 10A shows several reference numerals depicting components that have been, or will be, discussed herein. As such, assembly, placement, etc., of these components, in view of the disclosure herein, will be readily ascertainable by those of skill in the art.

### Optical Adjustment Components

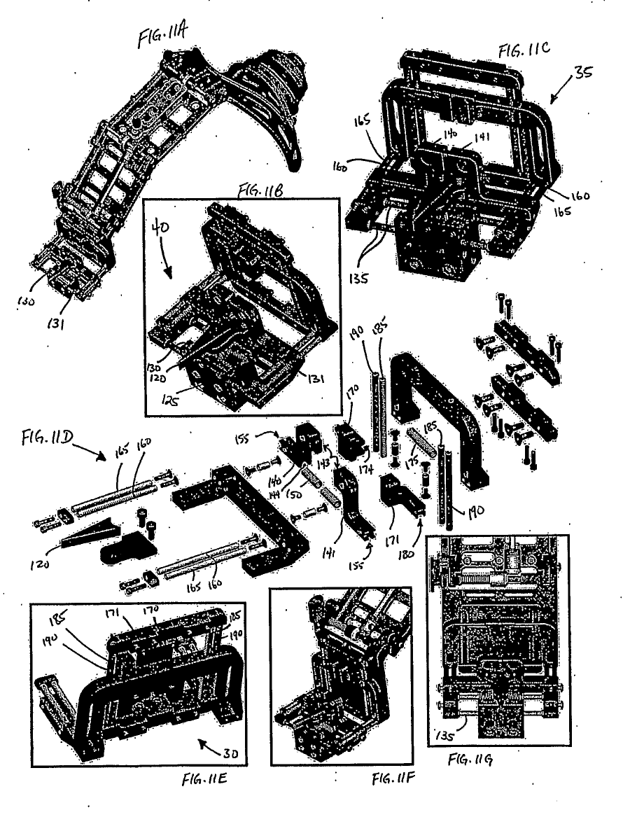

FIGS. 11A through 11G show details of optical adjustment mechanisms according to aspects of the invention. FIG. 11D, in particular, is an exploded view of the optical adjustment mechanisms. FIGS. 11A through 11C and 11E through 11G show various different views of the optical adjustment mechanisms. Under normal operation, after the HMD has been positioned on the head, the user is limited to viewing the display and optics image system directly in front of their eyes. In order to properly align the entire HMD system of the invention to match the user, all the mechanical and optical adjustments should be broth easily accessible and intuitively controlled by touch. In embodiments of the HMD according to the invention, there are a total of five mechanical and optical adjustments. The two mechanical adjustments are the head size adjustment (via the adjustment handle 11) and the flip-up option, both described above. The three most common optical adjustments include the interpupillary distance (IPD), vertex distance, and vertical distance, although other adjustments may be utilized. Mechanisms for effectuating these optical adjustments are described in greater detail below.

### Interpupillary Distance Adjustment

The interpupillary distance (IPD) adjustment mechanism 40 (depicted, for example, in FIGS. 3, 11B and 11D) is used to adjust the distance between the user's eyes. As such, the IPD is dependent upon the display and optical image system 1 held within the wrap around front optical cover 2. In embodiments, the IPD adjustment mechanism 40 is controlled by an IPD lever 120, located above the wrap around front optical cover 2. An IPD spur gear 125 is operatively coupled to and below the IPD lever 120, such that rotation of the IPD lever 120 causes rotation of the IPD spur gear 125. The IPD spur gear 125 is held between two mating spur gear racks 130, 131. In implementations, the spur gear racks 130, 131 are attached to two parts of the display and optical image system 1 (e.g., a right eye part and a left eye part) below and guided by rails 135 in mating holes. As the IPD lever 120 is rotated from the center position to the left or right sides, the spur gear racks 130, 131 push both the left and right eyes' associated display and optics image system apart or towards each other, respectively. In embodiments, the IPD adjustment mechanism 40 is mounted on the vertex adjustment mechanism 35, described below.

### Vertex Adjustment

The vertex adjustment mechanism 35 (depicted, for example, in FIGS. 3, 11C, and 11D) is used to move the entire display and optical image 1 system either closer to or farther from the user's eyes, so as to provide the user the optimal combination of comfort, focus, and field-of-view. In embodiments, the vertex adjustment mechanism 35 is operated by squeezing a pair of spring loaded finger controls 140, 141 with raised ridges and gently sliding all the attached parts. The finger controls 140, 141 comprise a male and female pair with mating receptacles 143, pockets 144 for compression springs 150, as well as dual protruded external ends 155 that engage into notched rails 160 enabling numerous incremental positions of lock down upon release of the spring loaded finger controls 140, 141 by the user. A second set of rails 165 and corresponding holes ensure smooth precision operation throughout the travel distance. In implementations, the vertex adjustment mechanism 35 is attached to the vertical member 3 and the vertical adjustment mechanism 30, described below.

### Vertical Adjustment

The vertical adjustment mechanism 30 (depicted, for example, in FIGS. 3, 11D, and 11E) is used to accommodate different head sizes and shapes, so as to ensure the user has the display and optical image system 1 vertically aligned to the position of their own eyes. In embodiments; the vertical adjustment mechanism 30 is also operated by squeezing a pair of spring loaded finger controls 170, 171 with raised ridges and gently sliding all the attached parts. For example, the vertical adjustment mechanism 30 comprises a smaller pair of spring loaded finger controls 170, 171 attached to the vertical member 3 and located just above and behind the vertex finger controls 140, 141. Similar to the vertex adjustment mechanism 35, the vertical adjustment mechanism 30 comprises machined male and female receptacles with recessed ridges, pockets 174 for compression spring 175, as well as dual protruded external ends 180 that engage into precision notched rails 185 enabling numerous incremental positions of lock down upon release of the spring loaded finger controls by the user. Another set of parallel rails 190 and corresponding holes ensure smooth precision operation throughout the travel distance.

All three optical adjustments described above permit a wide variable range of motion capable of being secured once set to the desired position, thereby preventing any movement during sudden head movement of normal HMD operation. Accordingly, implementations of the HMD of the present invention have taken into consideration the many different head sizes and shapes of the majority of the population, and defined both mechanical and optical adjustments with the necessary design range to accommodate them.

### Cable Connection

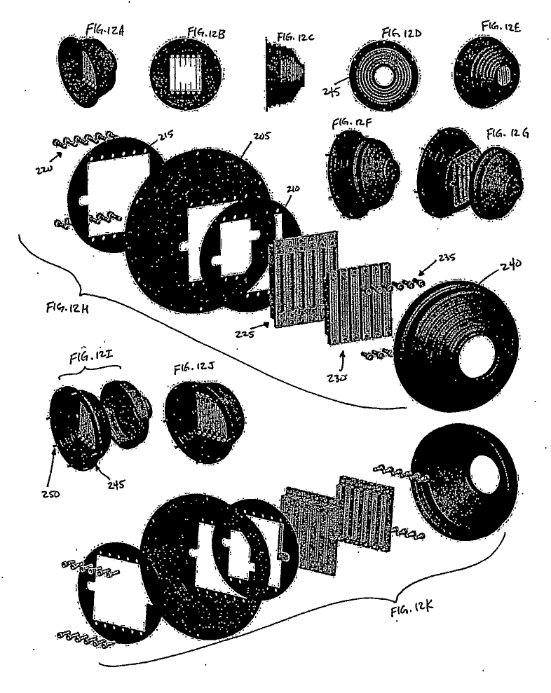

The flexible connector boot 7 is described with respect to FIGS. 12A through 12K. The flexible connector boot 7 attaches electrical signal cables to the HMD. In embodiments, the flexible connector boot 7 comprises a flexible connector boot member 205 sandwiched between first and second plates 210, 215. First fasteners 220 (such as, for example, screws) pass through the first and second plates 210, 215 and the flexible connector boot member 205, and affix a first electrical connector 225 thereto. Moreover, second electrical connector 230 is operatively coupled to the first electrical connector 225 by fasteners 235. A protective cover 240 may be disposed over the second electrical connector 230. The flexible connector boot 7 further comprises an attachment ring 245 (see FIGS. 12D and 12E) and third fasteners 250 that affix the flexible connector boot member 205 to the rear head support 6. By connecting the cables to one portion of flexible connector boot member 205 and connecting another portion of the flexible connector boot member 205 to the rear head support 6, the flexible connector boot 7 provides a flexible connection of cables to the remaining components of the HMD. In this manner, the HMD of the present invention allows enhanced head mobility of a user, without the problems associated with rigid cable connections.

In embodiments, the first electrical connector 225 and second electrical connector 230 each comprise an array of plural electrical connectors, such as, for example, male and female connectors to which wires may be attached. Such connectors are known in the art and do not require further description here. In this manner, various electrical cables may be connected between a computer cluster (not shown) and the second electrical connector 230, and between the first electrical connector 225 and the display and optical image system 1. Accordingly, electrical power and/or signals may be provided to the display and optical image system 1.

For example, in implementations, a cable assembly originating at a display image computer cluster enters the belt pack assembly 8 and is connected to a circuit board therein. The cable assembly then exits the belt pack assembly 8 and continues up the backside of the user, entering the flexible connector boot assembly 7. From the flexible connector boot assembly 7, the cable assembly splits into two bundles of cable channels 10 and continues through both sides of the open concave rear head support 6 and passes under the rear pivot shaft 55. The bundles continue across the base member 5, along both sides of the gear set 69 and below the adjustment handle 11. The bundles pass underneath the front pivot shaft 60 and continue down the front angle member 4. The bundles pass below the split pivot shaft 65 and continue down through the vertical member 3, before reaching the display and optical image system 1.

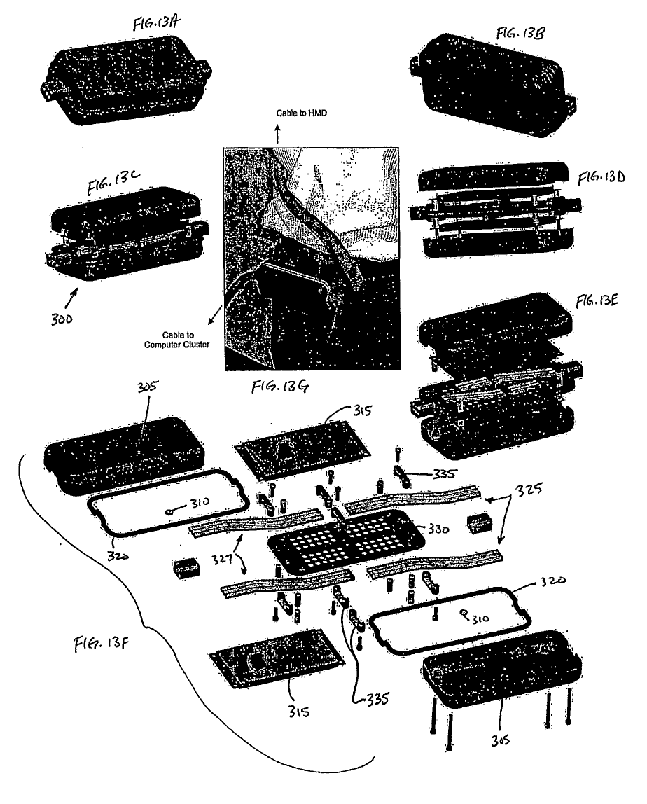

In embodiments, the belt pack assembly 8, as depicted in FIGS. 13A through 13G, includes a rugged two-sided enclosure 300 with access windows 305 for viewing typical LED indicator lights 310 on electronic printed circuit boards 315, and two continuous gaskets 320 around the outside edges for both seal protection from undesirable elements and short distance drops. In implementations, both the incoming and exiting cable harnesses 325, 327 for the two internal electronic printed circuit boards are securely mounted to a center plate 330 via multiple recessed cable clamps 335 located on either side of the center plate 330 at entry, exit, and center locations within the enclosure 300. This constitutes an internal bi-directional strain relief system that, combined with the mounting of the two electronic printed circuit boards 315 via standoffs to the center mounting plate 330, ensures that the cable assembly and the two internal electronic printed circuit boards 315 are secure during normal HMD operations. An adjustable belt-clip may be added onto the rear of the enclosure for improved user friendliness as well.

In this manner, a cable assembly may be connected between a computer and the belt pack 8, between the belt pack 8 and the flexible connector boot assembly 7, and between the flexible connector boot assembly 7 and the display and optical image system 1. Accordingly power and/or image signals, as are known in the art, may be provided to from the computer to the display and optical image system 1.

In embodiments, control electronics that control what images are displayed to the user via the display and optical image system 1 may be contained in the belt pack 8 and/or a computer cluster. Such electronics are known in the art, and any suitable system of control electronics may be used with the invention.

Embodiments of the inventive Head Mounted Display (HMD) offer the virtual reality industry a new extremely lightweight option that incorporates multiple mechanical and optical adjustments providing future generation technologies a user friendly alternative.

The following are exemplary features of the invention. These exemplary design features should not be considered limiting to the invention, and one of ordinary skill in the art should realize that other features, such as those described above, may also make up part of the invention. For example, implementations of the inventive HMD may be constructed with a lightweight plastic/aluminum construction, resulting in a weight of approximately two pounds. Additionally, the front-to-back, over-the-head, jointed design configuration provides improved centerline balance and hair management. Also, the simple, one-hand, tactile control of the five mechanical and optical adjustments (i.e., overall head size, ninety degree flip-up, interpupillary distance, vertex, and vertical) provides ease of use.

Moreover, embodiments of the invention provide protected and flexible cable management throughout the HMD, comfortable covered quick recovery foam, and durable external covers that allow for simple repair, modifications, and/or removal. Additionally, implementations of the inventive HMD may include audio headphone options, either separate from the HMD or internally incorporated therewith.

Embodiments of the invention include a flexible connector boot assembly, which provides user comfort and cable management. Additionally, a compact belt pack assembly may be used with the HMD. Such a belt pack assembly may include any combination of: a rugged electronics housing, cable dual strain relief system, LED status indicator windows, protective sealing gaskets, and an adjustable belt clip-on.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An apparatus, comprising:
a frame comprising a front frame portion adapted to rest on a front portion of a head of a user and a rear frame portion adapted to rest on a back portion of the head of the user;
at least one adjustment mechanism configured to secure the frame to the head of the user; and
a downwardly extending housing member proximate the front frame portion, the housing member being configured to house an optical display.

2. The apparatus of claim 1, wherein the frame is adjustable.

3. The apparatus of claim 2, wherein the rear frame portion is adjustable.

4. The apparatus of claim 2, wherein the at least one adjustment mechanism selectively adjusts a distance between the front frame portion and the rear frame portion.

5. The apparatus of claim 2, further comprising a mechanism configured to adjust a position of the optical display relative to eyes of the user.

6. The apparatus of claim 2, wherein the housing member remains substantially vertical during adjustment of the frame.

7. The apparatus of claim 2, wherein the at least one adjustment mechanism is located at a top portion of the frame.

8. The apparatus of claim 2, wherein the at least one adjustment mechanism comprises a rotatable mechanism configured to move at least a portion of the frame for securing the frame to the head of the user.

9. The apparatus of claim 2, wherein the at least one adjustment mechanism comprises two adjustment mechanisms, each being configured to adjust separate portions of the frame.

10. The apparatus of claim 2, wherein the at least one adjustment mechanism comprises a single adjustment mechanism that adjusts plural portions of the frame.

11. The apparatus of claim 10, wherein the single adjustment mechanism comprises a single rotational adjustment mechanism.

12. An assembly, comprising:
a frame comprising:
a base having a first end and a second end,
a first member coupled to the first end, and
a second member coupled to the second end;
an optical display housing; and
an adjustment mechanism structured to provide equal-angular countermovement of the first member and the second member relative to the base, and movement of the optical display housing.

13. The assembly of claim 12, further comprising a frame member coupled to the optical display housing and the first member.

14. The assembly of claim 13, wherein the adjustment mechanism is structured to provide movement of the frame member relative to the first member such that the optical display housing remains in a substantially vertical orientation relative to the base.

15. The assembly of claim 14, wherein, during adjustment, movement of the frame member relative to the first member is equal in magnitude and opposite in angular direction to movement of the first member relative to the base.

16. The assembly of claim 15, wherein, during adjustment, movement of the frame member relative to the first member is equal in magnitude and angular direction to movement of the second member relative to the base

17. The assembly of claim 13, wherein the frame member is hinge-mounted to the first member and is configured to lock at a first angle and a vertical angle relative to the base.

18. The assembly of claim 12, further comprising an interpupillary distance adjustment mechanism structured and arranged to adjust an optical display housed within the optical display housing.

19. The assembly of claim 18, wherein the interpupillary distance adjustment mechanism comprises a spur gear operatively engaged with two racks that are configured to move portions of the optical display toward or away from each other.

20. The assembly of claim 13, further comprising at least one of:
a vertex distance adjustment mechanism structured and arranged to adjust a vertex position of the optical display housing relative to the frame member; and
a vertical distance adjustment mechanism structured and arranged to adjust a vertical position of the optical display housing relative to the frame member.

21. The assembly of claim 20, wherein the vertex distance adjustment mechanism comprises biased finger controls that selectively allow the optical display housing to move along rails extending substantially horizontal with respect to eyes of a user.

22. The assembly of claim 20, wherein the vertical distance adjustment mechanism comprises biased finger controls that selectively allow the optical display housing to move along rails extending substantially vertical with respect to eyes of a user.

23. The assembly of claim 12, further comprising a flexible connector boot coupled to the second member and structured to connect cables from the optical display housing to cables from a signal source.

24. A head mounted display assembly, comprising:
a frame comprising:
a base adapted to rest on a top portion of a head of a user,
a front frame portion adapted to rest against a front portion of the head of the user, and
a rear frame portion adapted to rest against a back portion of the head of the user;
an optical display housing; and
an adjustment mechanism configured to adjust a distance between the front frame portion and the rear frame portion while maintaining the optical display housing at a constant angle relative to the base.

25. The head mounted display assembly of claim 24, further comprising a flexible connector boot coupled to the rear frame portion and connecting at least one signal cable from the optical display housing to at least one signal cable from a signal source.

26. The head mounted display assembly of claim 25, further comprising a belt-pack assembly connecting at least one signal cable from the flexible connector boot to the at least one signal cable from the signal source.

27. A head mounted display, comprising:
a C-shape frame member having contact points at a top, front and rear of a user's head;
at least one adjustment mechanism arranged with the C-shaped frame member and structured to adjust at least one of the contact points of the C-shaped frame member; and
a housing structured to house a optical display system proximate to a user's eyes and extending from the C-shape frame member.

28. The head mounted display of claim 27, wherein the contact point at the rear of the user's head is essentially concave shaped.
